(19) United States
(12) Patent Application Publication
(10) Pub. No.: US 2007/0221699 A1
(43) Pub. Date: Sep. 27, 2007

(54) STAPLERS WITH EFFORT-SAVING ARM ASSEMBLY

(76) Inventor: Hung Chieh Hsu, Taichung Hsien (TW)

Correspondence Address: BACON & THOMAS, PLLC, 625 SLATERS LANE, FOURTH FLOOR, ALEXANDRIA, VA, 22314, US

(21) Appl. No.: 11/386,714

(22) Filed: Mar. 23, 2006

(51) Int. Cl. B25C 5/02

(52) U.S. Cl. 227/134; 227/120

(57) ABSTRACT

A stapler includes a base which has two connection plates on a top thereof. A magazine assembly has one end pivotably connected to the base and an action member is pivotably connected to the two connection plates. The action member includes two first lugs and two protrusions extend from two respective outsides of the two first lugs. An action plate is connected to an end of the action member and located opposite to the first lugs. An arm is pivotably connected to the connection plates and includes two second lugs. Each second lug has a slot so that the two protrusions are movably engaged therewith. The second lugs of the arm pivot the first lugs on the action member to let the action plate on the action member to produce a large force to force a staple to penetrate the sheets.

### FIELD OF THE INVENTION

The present invention relates to a stapler and more particularly, to a stapler with an effort-saving arm assembly which provides larger pressing force to the sheets to be stapled.

### BACKGROUND OF THE INVENTION

A conventional stapler 60 is shown in FIG. 5 and generally includes a base 61 with an anvil 611 on a top of a first end of the base 61 and a U-shaped frame is connected to the top of a second end of the base 61 so that an arm 63 is pivotably connected to the U-shaped frame. A magazine assembly 62 is connected to the frame and includes a rod 64 with a spring 66 mounted thereto, a follow block 65 is connected to the rod 64 and pushed by the spring 66 such that the staples 67 in the magazine assembly 62 can be pushed toward the a distal end of the magazine assembly 62. A plate 68 has one end hooked with the hook 651 of the follow block 65 and the other end of the plate 68 is connected to an action member 631 fixedly to the in side of the arm 63. When the arm 63 is pivoted upward, the plate 68 pulls the follow block 65 backward so that the user can insert staples 67 in the magazine assembly 62. When the arm 63 is pivoted downward, the action plate 632 on the action member 631 forces one staple 67 out from an outlet in the underside of the magazine assembly 62 and the staple 67 penetrates through sheets (not shown) located between the magazine assembly 62 and the anvil 611. Two legs of the staple 67 are then bent inward by the anvil to staple the sheets. It is noted that the staple 67 has to be applied by a sufficient force to penetrate the sheets and the user's hand does not feel comfortable after frequent stapling actions.

The present invention intends to provide an effort saving stapler wherein the arm assembly of the stapler includes a movable action member which is lifted upward and moves toward the sheets to be stapled such that the user can easily operate the stapler with less effort.

### SUMMARY OF THE INVENTION

The present invention relates to a stapler which comprises a base with two connection plates on a top thereof and each of the connection plates has a first hole, a second hole and a third hole. An anvil is fixed on the top of a first end of the base. A magazine assembly has a first end pivotably connected to the connection plates and has a groove in which a follow block is received. A first spring biases the follow block to contact with staples. An outlet is defined in a first end of an underside of the magazine assembly and a second spring is connected between a second end of the magazine assembly and a second end of the base. A first pin extends through a hole in the second end of the magazine assembly and the first holes in the connection plates.

An action member is mounted on the magazine assembly and pivotably connected to the two connection plates by extending a second pin through two through holes in the action member and the third holes in the connection plates. Two first lugs extend from the action member and two protrusions extend from two respective outsides of the two first lugs. An action plate is connected to an end of the action member and located opposite to the first lugs.

An arm is mounted on the magazine assembly and pivotably connected to the connection plates by extending a third pin through aligned pivot holes in the arm and the second holes in the two connection plates. Two second lugs extend from the arm and each second lug has a slot. The two protrusions on the two first lugs of the action member are movably engaged with the two slots in the two second lugs. A product of a distance between a point of pressing to the second holes in the connection plates and a distance between the third holes in the connection plates and the protrusions is larger than a product of a distance between the second holes in the connection plates to the protrusions and a distance between the third holes to the action plate.

The primary object of the present invention is to provide an effort saving arm assembly for a stapler wherein the action member with the action plate has two protrusions which are movably engaged with two slots in the arm so that when the arm is pivoted, the action member can be easily pivoted by moving the protrusions in the slots so as to product a large force to let the staple penetrate the sheets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the stapler of the present invention;

FIG. 2 is an exploded view to show the stapler of the present invention;

FIG. 3 is a side view to show the stapler of the present invention;

FIG. 4A shows that the arm is pivoted;

FIG. 4B shows that the arm is completely pivoted and the staple penetrates through sheets, and

FIG. 5 shows a conventional stapler.

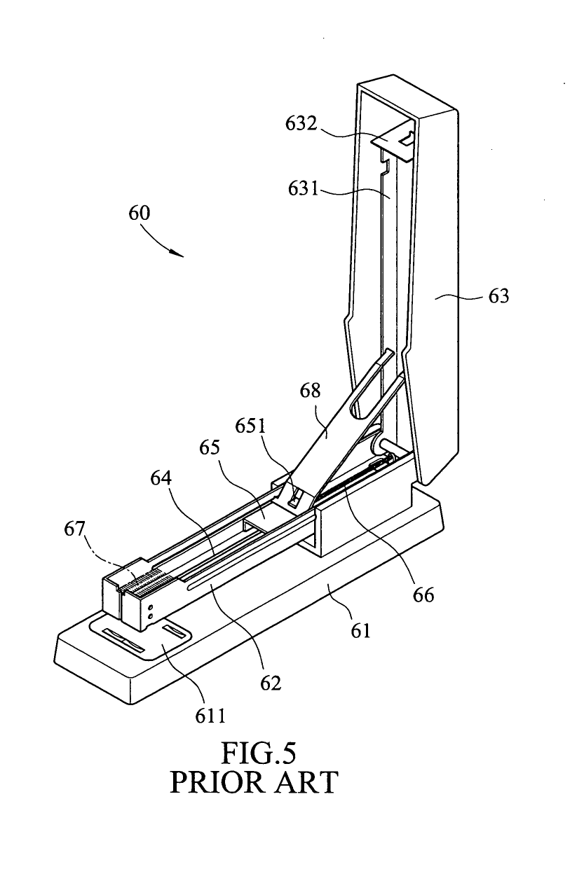

### DETAILED DESCRIPTION OF THE PREFERRED EMBODIMENT

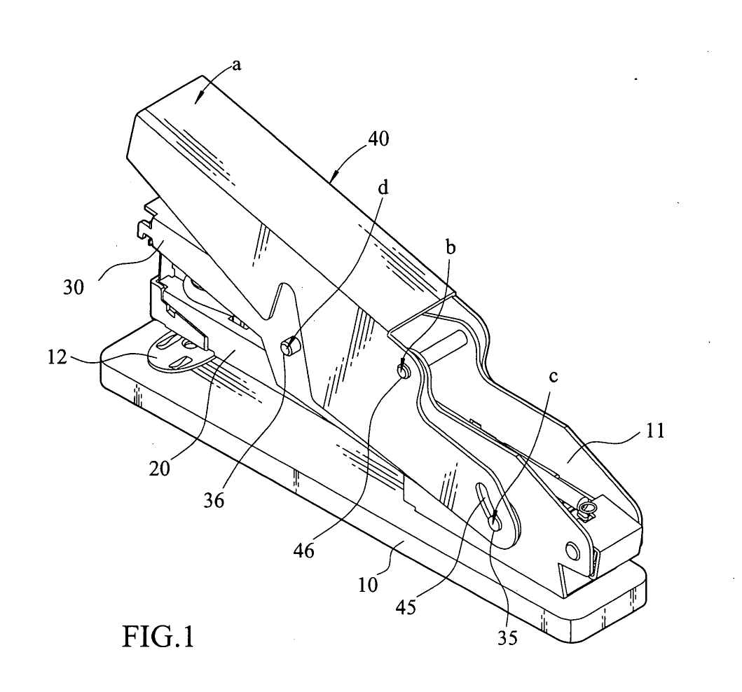

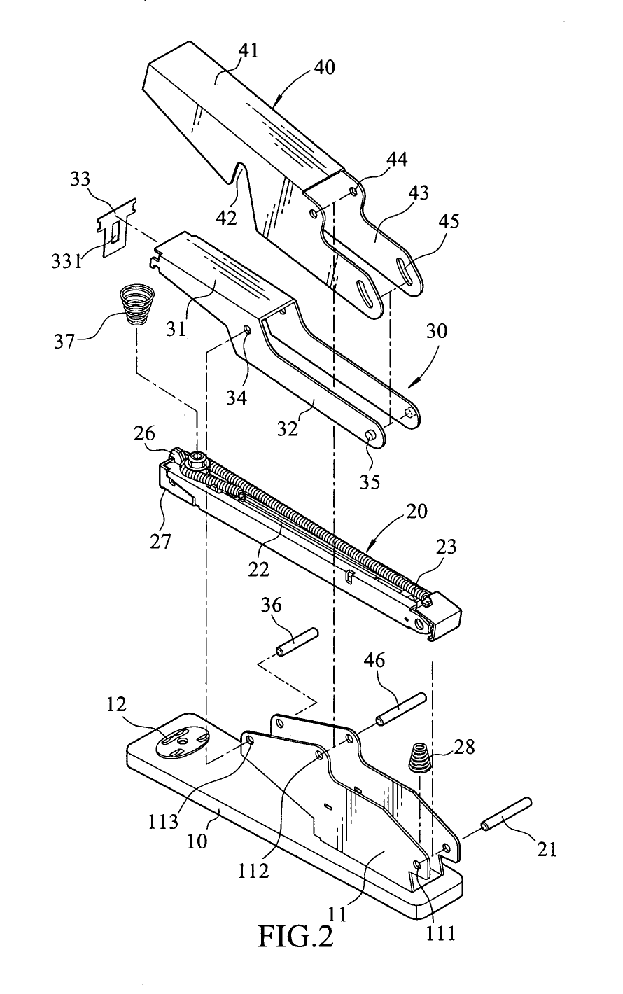

Referring to FIGS. 1 to 3, the stapler of the present invention comprises a base 10 having two connection plates 11 on a top thereof and each of the connection plates 11 has a first hole 111, a second hole 112 and a third hole 113. An anvil 12 is fixed on the top of a first end of the base 10.

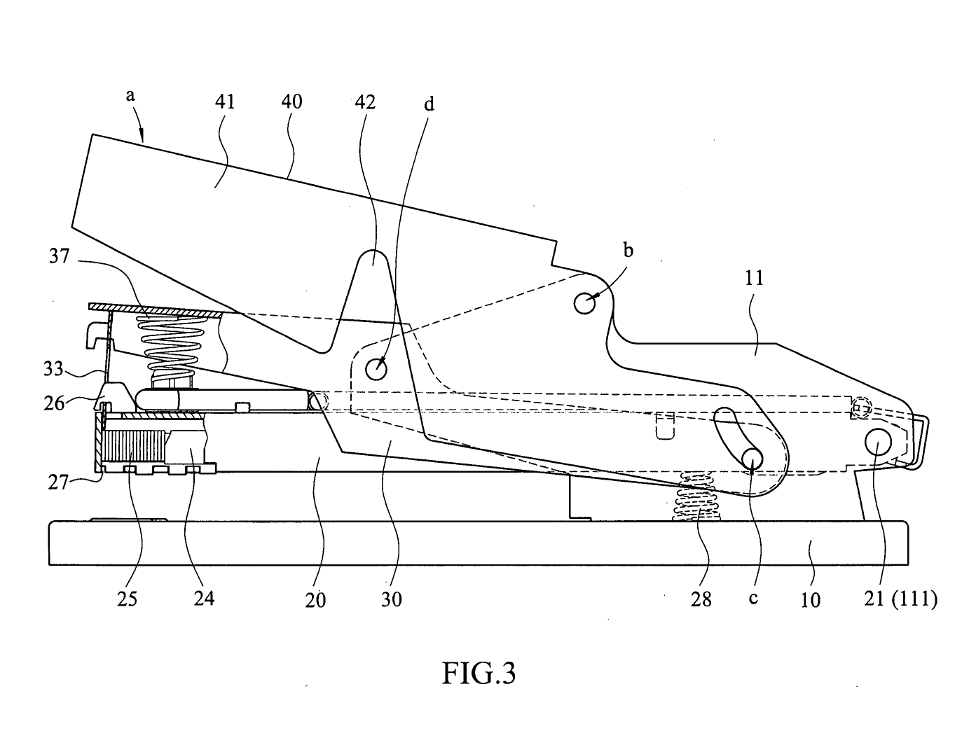

A magazine assembly 20 has a groove 22 defined therein and a follow block 24 is received in the groove 22. A first spring 23 biases the follow block 24 which is in contact with staples 25 as shown in FIG. 3. An outlet 27 is defined in a first end of an underside of the magazine assembly 20 and a second spring 28 is connected between a second end of the magazine assembly 20 and a second end of the base 10. A first pin 21 extends through a hole in the second end of the magazine assembly 20 and the first holes 111 in the connection plates 11. The magazine assembly 20 has a hook 26 on the first end thereof.

An action member 30 is mounted on the magazine assembly 20 and includes a U-shaped portion 31. Two first lugs 32 extend from the U-shaped portion 31 of the action member 30 and two protrusions 35 extend from two respective outsides of the two first lugs 32. The action member 30 is pivotably connected to the two connection plates 11 by extending a second pin 36 through two through holes 34 in a mediate portion of the action member 30 and the third holes 113 in the connection plates 11. An action plate 33 is connected to an end of the action member 30 and located opposite to the first lugs 32. The action plate 33 has an aperture 331 with which the hook 26 is engaged. A third spring 37 is connected between the first end of the magazine assembly 20 and the U-shaped portion 31 of the action member 30, the third spring 37 is located close to the action plate 33.

An arm 40 is mounted on the magazine assembly 20 and is pivotably connected to the connection plates 11 at pivot point “b” by extending a third pin 46 through aligned pivot holes 44 in the arm 40 and the second holes 112 in the two connection plates 11. Two second lugs 43 extend from the arm 40 and each second lug 43 has a slot 45. The two protrusions 35 on the two first lugs 32 of the action member 30 are movably engaged with the two slots 45 in the two second lugs 43. The two protrusions 35 from a pivot point “c”. The arm 40 includes a U-shaped portion 41 and two notches 42 are defined in two respective lower edges of two sides of the U-shaped portion 41. Two ends of the second pin 36 are movably received in the notches 42 and the second pin 36 forms a pivot point “d”.

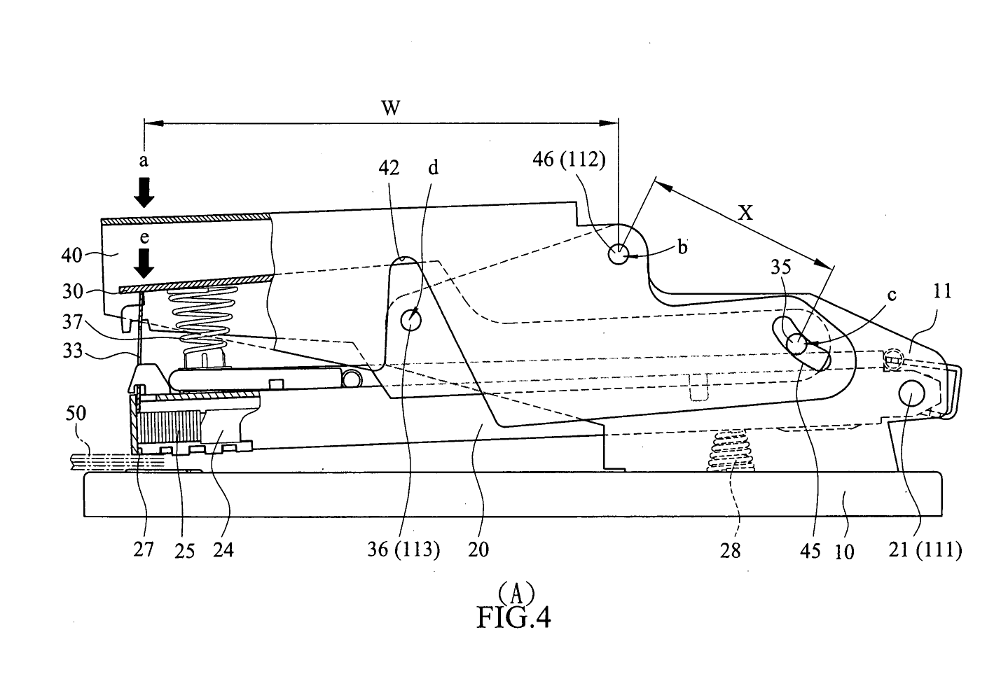

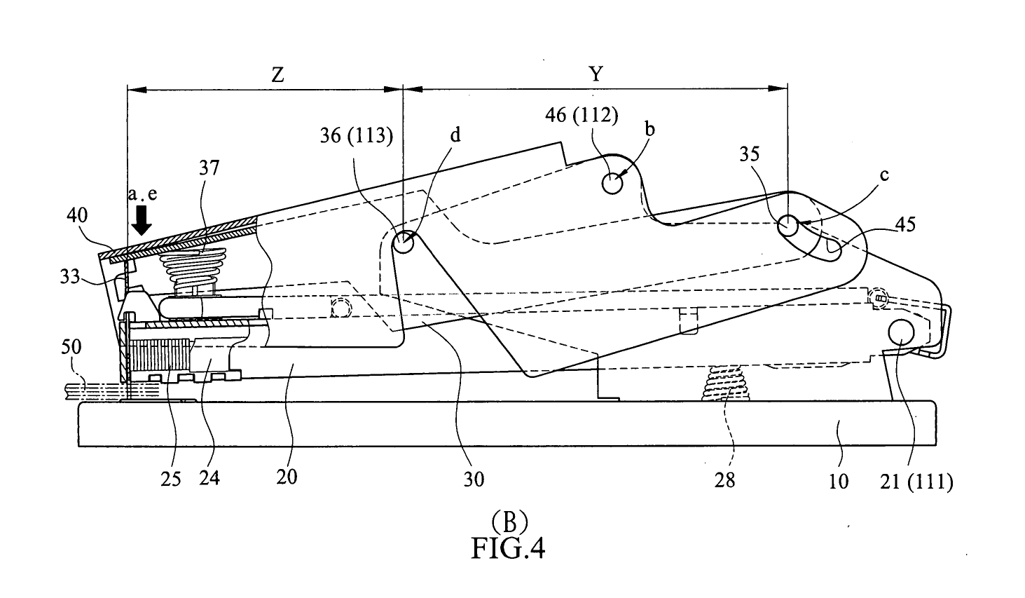

Referring to FIGS. 4A and 4B, sheets 50 to be stapled are put between the base and the magazine assembly 20, the user then pivots the arm 40 downward at a point of pressing “a” and the action plates 33 is applied by the force at point “e” and lowered and forces a staple 25 out from the outlet 27 to penetrate through the sheets 50. The two legs of the staple 25 are then bent inward on the anvil 12 to staple the sheets 50.

Assume that a distance between a point of pressing “a” to the second holes 112 (pivot point “b”) in the connection plates 11 is represented by “W”, and a distance between the third holes 113 (pivot point “d”) in the connection plates 11 and the protrusions 35 (pivot point “c”) is represented by “Y”. A distance between the second holes 112 (pivot point “b”) in the connection plates 11 to the protrusions 35 (pivot point “c”) is represented by “X” and a distance between the third holes 113 (pivot point “d”) to the point “e” of the action plate 33 is represented by “Z”. In the present invention, the product of “WY” is larger than the product “XZ”. When pressing the arm 40, the action member 30 is easily pivoted about the second pin 36 by moving the protrusions 35 in the slots 45, and the action plate 33 generates a large force to push a staple 25 out from the outlet 27 to staple the sheets 50. When the stapling action is finished, the arm 40 is released and the third spring 37 pushes the action member 30 upward and the protrusions 35 move back in the slots 45 so as to quickly pivot the arm 40 back to its original position. The magazine assembly 20 is pushed to its original position by the second spring 28. By the specific arrangement, the action member 30 produces a slow and large force to the staple 25, and the user can use less effort to press the arm 40.

While we have shown and described the embodiment in accordance with the present invention, it should be clear to those skilled in the art that further embodiments may be made without departing from the scope of the present invention.

1. A stapler comprising:
a base having two connection plates on a top thereof and each of the connection plates having a first hole toward a rear end of the connection plate, a third hole forward of the first hole, and a second hole between the first and the third hole, an anvil fixed on the top of a forward end of the base;
a magazine assembly having a groove defined therein and a follow block received in the groove, a first spring biasing the follow block which is in contact with staples, an outlet defined in a first end of an underside of the magazine assembly and a second spring connected between a second end of the magazine assembly and a second end of the base, a first pin extending through a hole in the second end of the magazine assembly and the first holes in the connection plates;
an action member mounted on the magazine assembly and pivotably connected to the two connection plates by extending a second pin through two through holes in the action member and the third holes in the connection plates, the first lugs extending from the action member and two protrusions extending from two respective outsides of the two first lugs, an action plate connected to a forward end of the action member and located opposite to the first lugs, and
an arm mounted on the magazine assembly and pivotably connected to the connection plates by extending a third pin through aligned pivot holes in the arm and the second holes in the two connection plates, two second lugs extending from the arm and each second lug having a slot, the two protrusions on the two first lugs of the action member movably engaged with the two slots in the two second lugs, a product WY of a distance W between a point of pressing near a forward end of the arm and the second holes in the connection plates and a distance Y between the third holes in the connection plates and the protrusions being larger than a product XZ of a distance X between the second holes in the connection plates and the protrusions and a distance Z between the third holes and a point on the action plate corresponding to the point of pressing.

2. The stapler as claimed in claim 1, wherein the magazine assembly has a hook on the first end thereof and the action plate has an aperture with which the hook is engaged.

3. The stapler as claimed in claim 1, wherein a third spring is connected between the first end of the magazine assembly and a U-shaped portion of the action member, the third spring is located close to the action plate.

4. The stapler as claimed in claim 1, wherein the arm includes a U-shaped portion and two notches are defined in two respective lower edges of two sides of the U-shaped portion, two ends of the second pin are movably received in the notches.
